(19) United States
(12) Patent Application Publication
(10) Pub. No.: US 2005/0231346 A1
(43) Pub. Date: Oct. 20, 2005

(54) Tire monitoring system

(75) Inventors: Hidemi Ichinose, Suzuka-shi (JP); Yasuhiro Kono, Suzuka-shi (JP)

Correspondence Address: RANKIN, HILL, PORTER & CLARK LLP, 4080 ERIE STREET, WILLOUGHBY, OH, 44094-7836, US

(73) Assignee: Honda Giken Kogyo Kabushiki Kaisha, Tokyo (JP)

(21) Appl. No.: 10/495,706

(22) PCT Filed: Nov. 14, 2002
(86) PCT No.: PCT/JP02/11885

§ 371 Date: May 14, 2004

(30) Foreign Application Priority Data
Nov. 16, 2001 (JP) 2001-351954

(51) Int. Cl. B60C 23/00

(52) U.S. Cl. 340/447

(57) ABSTRACT

According to the present invention, there is provided a tire monitoring system in which electric power is fed from a car body to a tire sensor unit in a non-contact manner. The tire sensor unit 10 (10a-10d) is mounted on a corresponding tire 2 (2a-2d) of a car, and electric power is radio-transmitted from a corresponding non-contact type power supply portion 40 (40a-40d) provided in the car body to the tire sensor unit 10 by electromagnetic induction or by microwaves. The tire sensor unit 10 is provided with a non-contact type power receiving portion which generates direct-current power by energy transmitted from the non-contact type power supply portion 40 so as to supply electric power necessary for activating the tire sensor unit 10. The tire sensor unit 10 senses air pressure or the like, and radio-transmits the information to the receiving device 20.

### TECHNICAL FIELD

This invention relates to a tire monitoring system for monitoring a tire condition of a car such as tire pressure, and more particularly a tire monitoring system in which electric power is fed from the car body to a tire sensor unit mounted on each tire in a non-contact manner.

### BACKGROUND ART

Japanese Unexamined Patent Publication No. H09-509488 discloses an active integrated circuit transponder and a sensor apparatus for sensing and transmitting car tire parameter data (tire pressure, tire temperature, number of tire rotations). Specifically, the active integrated circuit transponder with on-board power supply is mounted in a car tire, and a pressure sensor, a temperature sensor and a tire rotation sensor are mounted on a substrate along with the integrated circuit transponder chip, the power supply and an antenna. Upon receiving an interrogation signal from a remote source, the transponder transmits an encoded radio frequency signal containing the above-mentioned parameter data to the remote source.

Japanese Unexamined Patent Publication No. 2000-289418 discloses a power supply unit for a built-in type tire pressure sensor. Specifically, the tire pressure sensor is provided inside a car tire and a battery is secured to the outside of the tire so that the battery can be directly detached and exchanged outside the car tire.

The conventional tire sensor unit uses a battery as a power supply, and the battery needs to be replaced. It is possible to extend a period of battery replacement by employing a battery having a large capacity. However, if a large-size battery is attached to a tire, a laborious process becomes necessary to adjust the weight balance of the tire.

The present invention has been made to solve the above-mentioned problem, and the object of the present invention is to provide a tire monitoring system which employs a tire sensor unit with no battery.

### DISCLOSURE OF THE INVENTION

In order to solve the above-mentioned problem, according to the present invention, there is provided a tire monitoring system comprising a tire sensor unit which is mounted on each tire of a car to radio-transmit information of a tire condition, a receiving device which is provided in the car body to receive the information of the tire condition transmitted from the tire sensor unit, and a display device to display the tire condition based on the information of the tire condition received at the receiving device, and further comprising a non-contact type power supply portion which is provided in the car body to radio-transmit energy, and a non-contact type power receiving portion which is provided in the tire sensor unit to generate direct-current power by the energy transmitted from the non-contact type power supply portion, wherein electric power necessary for activating the tire sensor unit is supplied from the non-contact type power receiving portion.

The radio-transmission of energy from the non-contact type power supply portion to the non-contact type power receiving portion may be conducted by electromagnetic induction or by microwaves.

In the tire monitoring system according to the present invention, electric power is fed from the car body to the tire sensor unit mounted on each tire in a non-contact manner. Consequently, the tire sensor unit can dispense with a battery, and it becomes unnecessary to replace a battery. Also, since it is unnecessary to attach a battery to the tire, the process for adjusting the weight balance of the tire can be conducted as easily as in the conventional art.

### BRIEF DESCRIPTION OF THE DRAWINGS

FIG. 1 is an overall block diagram of a tire monitoring system according to the present invention;

FIG. 2 is a block diagram of a tire sensor unit;

FIG. 3 is a view showing one example of a format of radio transmission data;

FIG. 4 is a graph showing the relationship between tire pressure and tire internal temperature;

FIG. 5 is a block diagram showing one example of a non-contact type power supply portion and a non-contact type power receiving portion;

FIG. 6 is a block diagram showing another example of a non-contact type power supply portion and a non-contact type power receiving portion; and

FIG. 7 is a diagram showing one example of a structure of the tire sensor unit.

### BEST MODE FOR CARRYING OUT THE INVENTION

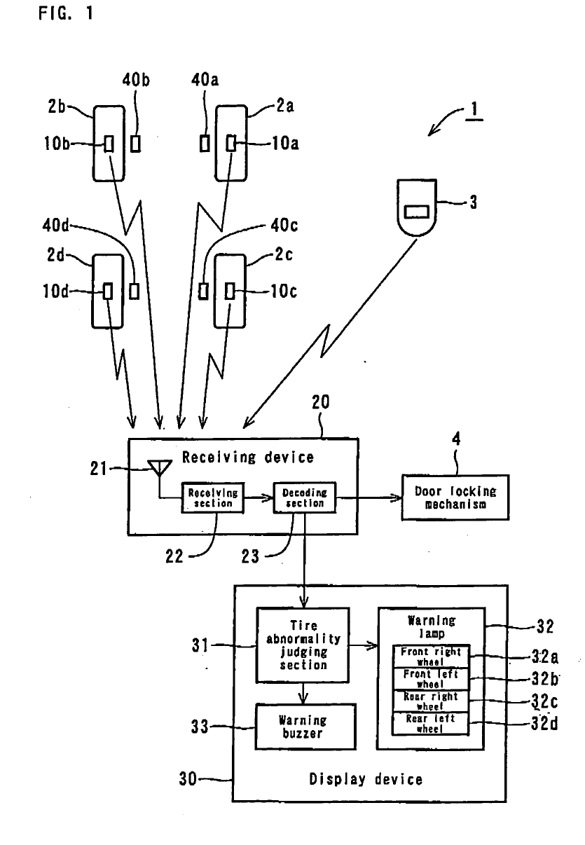

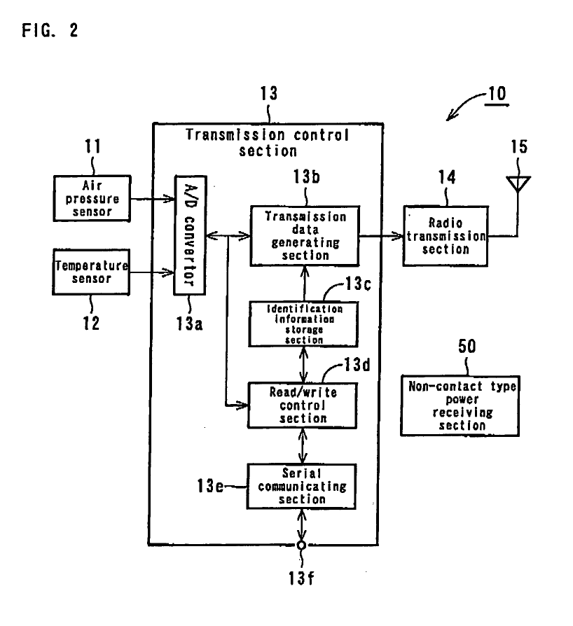

Hereinafter, embodiments of the present invention will be described with reference to the attached drawings. FIG. 1 is an overall block diagram of a tire monitoring system according to the present invention, and FIG. 2 is a block diagram of a tire sensor unit.

As shown in FIG. 1, a tire monitoring system 1 is comprised of tire sensor units 10 (10a, 10b, 10c, and 10d), each being mounted on a respective tire 2 (a front right wheel 2a, a front left wheel 2b, a rear right wheel 2c, and a rear left wheel 2d) of a car, a receiving device 20 which is provided in the car body, a display device 30 which is provided in the car body, and non-contact type power supply portions 40 (40a, 40b, 40c, and 40d), each being provided in the car body and adjacent to the respective tire 2. The non-contact type power supply portion 40 is activated by electric power supplied from a battery of the car, and the non-contact type power supply portion 40 supplies electric power to the tire sensor unit 10 in a non-contact manner. The non-contact type power supply portion 40 may be provided in an area for mounting a wheel speed sensor which constructs an anti-lock braking system (ABS). Also, the non-contact type power supply portion 40 may be provided in a molding member or a trim member which serves for protection or anti-rusting of a contact portion between an inner board and an outer board of a wheel arch flange portion. In the drawing, reference numeral 3 is a portable transmitter (i.e., a keyless entry signal transmitter) and reference numeral 4 is a door locking mechanism. The portable transmitter 3, the receiving device 20, and the door locking mechanism 4 form a keyless entry system for remote-controlling the locking and unlocking operation of a car door.

In the present embodiment, the keyless entry system for remote-controlling the locking and unlocking operation of a door is shown as one example, but the opening and closing operation of a trunk, opening and closing operation of a power window or the like can also be remote-controlled.

The receiving device 20 is provided with a receiving antenna 21, a receiving section 22 for amplifying and demodulating a high frequency signal received at the antenna 21 to output data transmitted from each tire sensor unit 10 and the portable transmitter 3, and a decoding section 23 for decoding received data output from the receiving section 22.

The decoding section 23 first judges whether the received data is directed to a driver's own car based on the car identification information among the received data. If the received data is directed to the driver's own car, the decoding section 23 judges whether the received data is that transmitted from the portable transmitter 3 or that transmitted from the tire sensor unit 10 based on the signal classification identification information among the received data. When the received data is that for a keyless entry system such as door locking/unlocking request data, the decoding section 23 supplies the data to the door locking mechanism 4. The door locking mechanism 4 performs the locking/unlocking operation of a door based on the door locking/unlocking request data supplied from the receiving device 20. When the received data is that transmitted from the tire sensor unit 10, the decoding section 23 supplies the received data to the display device 30.

The decoding section 23 may be constructed so as to supply the received data excluding the car identification information to the door locking mechanism 4 and the display device 30 in a case where the received data is directed to the driver's own car. In this instance, the door locking mechanism 4 and the display device 30 judge whether the received data is that for the keyless entry system or that for the tire monitoring system.

Alternatively, the receiving device 20 may be constructed of the antenna 21 and the receiving section 22 and supply the received data to the door locking mechanism 4 and the display device 30. In this instance, the door locking mechanism 4 and the display device 30 have a decoding section to judge whether the received data is that for the driver's own car, or that for the keyless entry system or that for the tire monitoring system. The car identification information for the keyless entry system can be different from the car identification information for the tire monitoring system.

The display device 30 is provided with a tire abnormality judging section 31, a warning lamp 32, and a warning buzzer 33. The construction and operation of the display device 30 will be described later.

As shown in FIG. 2, the tire sensor unit 10 comprises an air pressure sensor 11, a temperature sensor 12, a transmission control section 13, a radio transmission section 14, an antenna for transmission 15, and a non-contact type power receiving portion 50. The non-contact type power receiving portion 50 generates direct-current power by energy transmitted from the non-contact type power supply portion 40 shown in FIG. 1, and the tire sensor unit 10 is activated by the direct-current power supplied from the non-contact type power supply portion 40. The transmission control section 13 is provided with an A/D converter 13a, a transmission data generating section 13b, an identification information storage section 13c, a read/write control section 13d, and a serial communicating section 13e. Reference numeral 13f is an input/output terminal group for serial data.

Output of the air pressure sensor 11 and output of the temperature sensor 12 are supplied to the A/D converter 13a to be converted to digital data (i.e., air pressure data, temperature data) by the A/D converter 13a. The identification information storage section 13c is constructed using a nonvolatile memory or the like and stores the car identification information (car ID) and the tire identification information (tire ID) therein. It is possible to reset the car identification information (car ID) and the tire identification information (tire ID) stored in the identification information storage section 13c by supplying the read/write control section 13d with a write command, the car identification information (car ID) and the tire identification information (tire ID) via the serial communicating section 13e. Also, it is possible to output the air pressure data and the temperature data to the outside via the serial communicating section 13e by supplying the read/write control section 13d with a sensor data read command via the serial communicating section 13e. Accordingly, it is possible to check the operation of each sensor 11, 12 and the A/D converter 13a by utilizing this sensor data reading function.

The transmission data generating section 13b starts the A/D converting operation of the A/D converter 13a at predetermined time intervals to obtain the air pressure data and the temperature data and temporarily stores the obtained data. The transmission data generating section 13b obtains the air pressure difference between the previously obtained air pressure data and the newly obtained air pressure data. The transmission data generating section 13b also obtains the temperature difference between the previously obtained temperature data and the newly obtained temperature data. When the air pressure difference is higher than a predetermined pressure change allowance and the temperature difference is higher than a predetermined temperature change allowance, the transmission data generating section 13b generates transmission data to be supplied to the radio transmission section 14.

The radio transmission section 14 generates a signal which is obtained by modulating a carrier wave of a predetermined carrier frequency with a predetermined modulating method based on the transmission data, and radio-transmits the signal from the antenna 15. The frequency of the carrier wave and the modulating method thereof are the same as the portable transmitter (i.e. a keyless entry signal transmitter). In other words, the specification of radio signal of the keyless entry system and the specification of the radio signal of the tire monitoring system are provided in common. In this manner, it is possible to receive the information on the tire using the receiving device for the keyless entry system.

The transmission data comprises the car identification information (car ID), the tire identification information (tire ID), the air pressure data, and the temperature data. The tire identification information (tire ID) includes the information for distinguishing among a front right wheel, a front left wheel, a rear right wheel, and a rear left wheel. The tire identification information (tire ID) can include the information on the type of tire.

In the case where the transmission data of the keyless entry system is in the order of the preamble data, the frame synchronizing data, and the data to be transmitted, the transmission data generating section 13b generates the transmission data of the same data format as above. Further, the transmission data generating section 13b can generate the error check data such as the CRC (Cyclic Redundancy Check) data with respect to the data to be transmitted (i.e., the car identification information, the tire identification information, the air pressure data, and the temperature data), and the generated error check data can be added thereto. By adding the error check data, the receiving device can check presence of an error in the receiving signal and correct the error.

The transmission data generating section 13b can transmit the data (first time) via the radio transmission section 14, transmit the same data (second time) when the randomly set time has passed, and then transmit the same data again (third time) when the randomly set time has passed since the second time transmission. In this manner, since the radio transmission timing from a plurality of tire sensor units 10 coincides with each other, the receiving device can correctly receive the data.

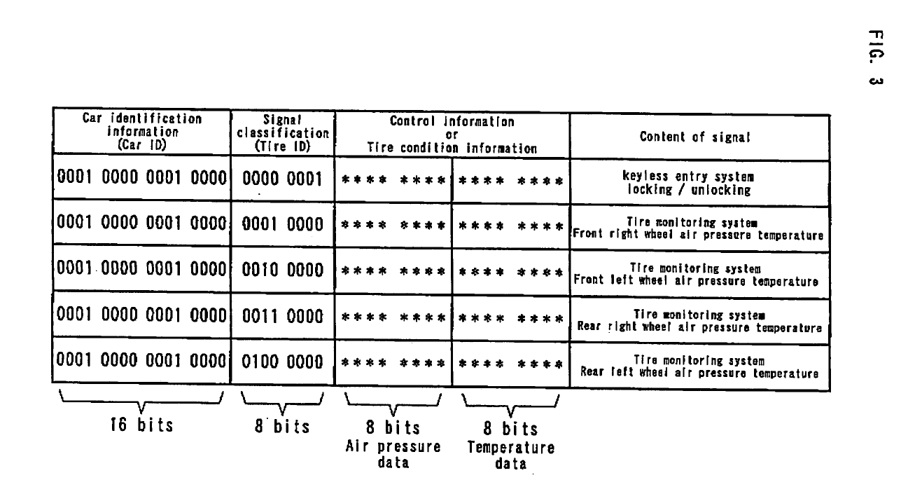

FIG. 3 is a view showing one example of a format of the radio transmission data. The portable transmitter 3 and the tire sensor unit 10 transmit the data of 40 bits in total. The first 16 bits of data show the car identification information (car ID), the next 8 bits of data show the signal classification, and the last 16 bits of data show the control information or the tire condition information. The data is distinguished into the signal for the keyless entry system or the signal for the tire monitoring system by the signal classification. In the case of the signal for the tire monitoring system, the signal classification becomes the tire identification information (tire ID), and with this tire identification information (tire ID), a front right wheel, a front left wheel, a rear right wheel, and a rear left wheel are distinguished. In the signal for the keyless entry system, the upper 8 bits of the control information show the door locking control information, while the lower 8 bits of the control information show the door unlocking control information. In the signal for the tire monitoring system, the upper 8 bits of the tire condition information are the tire pressure data, while the lower 8 bits of the tire condition information are the tire internal temperature data.

The tire abnormality judging section 31 within the display device 30 shown in FIG. 1 judges whether the tire is abnormal or not based on the tire identification information (tire ID), the air pressure data, and the temperature data supplied from the receiving device 20. If the tire was judged to be abnormal, the tire abnormality judging section 31 lights the warning lamp 32 and buzzes the warning buzzer 33 to inform that the tire abnormality was detected. The warning lamp 32 is provided with indicators 32a-32d corresponding to each tire so as to visibly indicate which tire is abnormal.

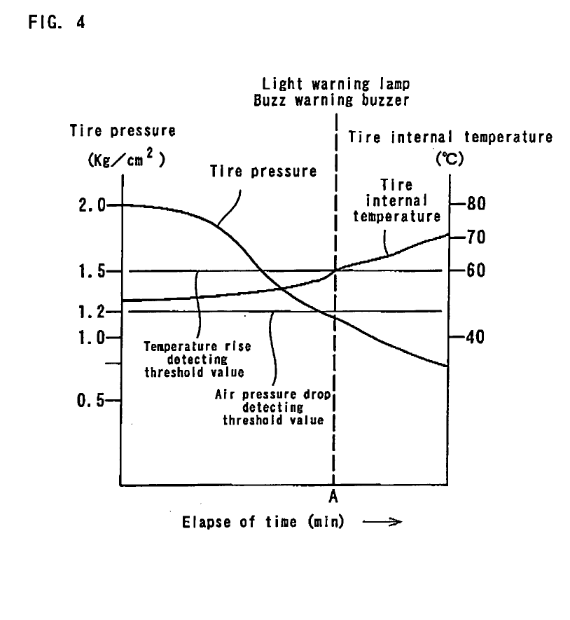

FIG. 4 is a graph showing the relationship between the tire pressure and the tire internal temperature. Usually, the tire pressure is about 2.0 Kg/cm² and the tire internal temperature is 50° C.-60° C. When the tire is punctured, the air pressure drops to 1.2 Kg/cm²-0.8 Kg/cm² and the tire internal temperature goes up to 60° C.-70° C. Accordingly, in the present embodiment, an air pressure drop detecting threshold value is set to 1.2 Kg/cm² and a temperature rise detecting threshold value is set to 60° C., respectively.

The tire abnormality judging section 31 lights the warning lamp 32 and buzzes the warning buzzer 33 at a point A when the tire pressure is lower than the air pressure drop detecting threshold value and the tire internal temperature is higher than the temperature rise detecting threshold value. In this manner, the tire abnormality judging section 31 can inform the driver and the like of the abnormality of the tire. Since which tire is abnormal is displayed by the indicators 32a-32d, the tire which needs the inspection, repair, change or the like can be easily found.

The warning lamp 32 can be provided with an indicator for showing the air pressure drop and an indicator for showing the tire internal temperature rise. In this instance, the tire abnormality judging section 31 can judge the air pressure drop and the tire internal temperature rise respectively and display the air pressure drop and the tire internal temperature rise independently. Further, a voice synthesizer can be provided in place of the warning buzzer 33 so that the abnormality of tire can be informed by a voice message saying for example “the air pressure of the right front wheel is decreasing”.

In the present embodiment, it is shown that the information on the tire pressure and the tire internal temperature transmitted from the tire sensor unit 10 is received at the receiving device 20 and the tire abnormality is judged on the car based on the received tire pressure and tire internal temperature. However, the tire abnormality judging section can be provided inside the tire sensor unit 10 to radio-transmit the tire abnormality detecting information in the case where the tire is judged abnormal.

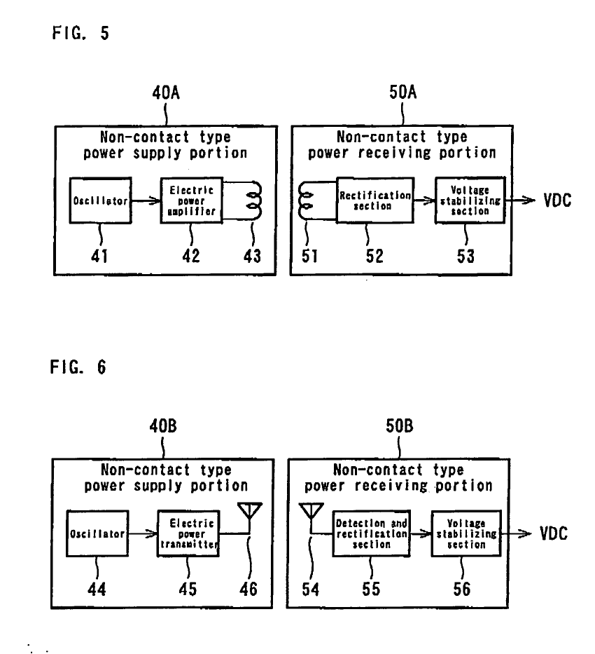

FIG. 5 is a block diagram showing one example of the non-contact type power supply portion and the non-contact type power receiving portion. In the example shown in FIG. 5, electric power is transmitted by electromagnetic induction. The non-contact type power supply portion 40A using electromagnetic induction comprises an oscillator 41 which generates a signal having a high frequency of several 10 KHz-several 100 KHz, and an electric power amplifier 42 which amplifies the signal so as to activate a transmitting side coil (primary coil) 43. The non-contact type power receiving portion 50A using electromagnetic induction comprises a receiving side coil (secondary coil) 51 which is coupled to the transmitting side coil 43 by electromagnetic induction, a rectification section 52 which rectifies the alternating current induced by the receiving side coil 43 and smoothes, and a voltage stabilizing section 53 which outputs voltage-stabilized direct current VDC based on the direct-current electric power output from the rectification section 52. The voltage-stabilized direct current VDC output from the voltage stabilizing section 53 is fed into each section (the air pressure sensor 11, the temperature sensor 12, the transmission control section 13, the radio transmission section 14) of the tire sensor unit 10 shown in FIG. 2.

FIG. 6 is a block diagram showing another example of the non-contact type power supply portion and the non-contact type power receiving portion. In the example shown in FIG. 6, electric power is transmitted by microwaves. The non-contact type power supply portion 40B using microwaves comprises an oscillator 44 which generates a signal having a high frequency of several GHz (gigahertz), and an electric power transmitter 45 which amplifies the signal so as to transmit from a transmitting side antenna 46. The non-contact type power receiving portion 50B using microwaves comprises a receiving side antenna 54 which receives the microwaves transmitted from the transmitting side antenna 46, a detection and rectification section 55 which detects and rectifies the received microwaves, and a voltage stabilizing section 56 which outputs voltage-stabilized direct current VDC based on the direct-current electric power output from the detection and rectification section 55. The voltage-stabilized direct current VDC output from the voltage stabilizing section 56 is fed into each section (the air pressure sensor 11, the temperature sensor 12, the transmission control section 13, the radio transmission section 14) of the tire sensor unit 10 shown in FIG. 2. Incidentally, the non-contact type power supply portion 40B and the non-contact type power receiving portion 50B are comprised of a GaAs semiconductor.

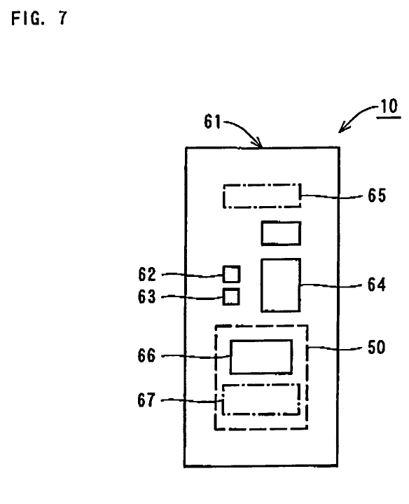

FIG. 7 is a diagram showing one example of the structure of the tire sensor unit. In the tire sensor unit 10, a semiconductor pressure sensor chip 62 which constructs the air pressure sensor, a semiconductor temperature sensor chip 63 which constructs the temperature sensor, a single microcomputer chip 64 and the like are mounted on a sheet-like substrate 61 having flexibility (such as a flexible substrate). Also, an antenna pattern for transmission 65 is formed on the substrate 61. In addition, the non-contact type power receiving portion 50 is provided on the substrate 61. Reference numeral 66 is a circuit for power supply which constructs the rectification section or the detection and rectification section, and the voltage stabilizing section. Reference numeral 67 is an energy receiving region in which the receiving side coil or the receiving side antenna is formed. By forming the tire sensor unit 10 on the sheet-like substrate 61 having flexibility, it is possible to install the tire sensor unit 10 in the tire or in the rubber of the tire.

In a case where the tire sensor unit 10 is installed on the surface of the tire wheel, if a common adhesive is used, thixotropy caused by a plasticizer which is a component of the adhesive will be a problem. Specifically the surface of the wheel and the sheet-like substrate 61 will be corroded during the use of a long period of time, and thereby the sheet-like substrate 61 will be peeled from the surface of the tire wheel. Accordingly, an adhesive whose main component is a silyl group special polymer is used in the present invention.

Conventional adhesive:

| | |
|---|---|
| rubber (butyl rubber) | 20 weight % |
| resin (C9 petroleum resin) | 10 weight % |
| plasticizer (petroleum C4 fraction) | 35 weight % |
| filler (talc) | 35 weight % |
| reaction catalyst etc. | 2 weight % |
| Adhesive used in the present invention | 57 weight % |
| silyl group terminal polymer | |
| (polypropylene oxide + dimethoxysilyl group) | |
| inorganic filler | 40 weight % |
| reaction catalyst etc. | 3 weight % |

Since the adhesive used in the present invention does not include a plasticizer, the strong adhesion can be maintained for a long period of time, and the adhesion can be exerted on various kinds of metal and plastic. The inorganic filler content is preferably 35-45 weight % for imparting a sufficient structure to the adhesive. The adhesive cannot exert sufficient adhesion without having a predetermined thickness. If the inorganic filler content is 35 weight % or less, there is a possibility that the adhesive will drop until it is cured and the adhesive will not be able to keep the predetermined thickness. If the inorganic filler content is 45 weight % or more, there is a possibility that the adhesive cannot be applied uniformly.

The following is the strength of the adhesion (Kg/cm²) with respect to each material in the case where the rate of straining the adhesive is set to be 50 mm/min.

| Metal: | |
|---|---|
| aluminum | 67 |
| iron (SPCC-SB) | 55 |
| stainless steel | 45 |
| copper | 46 |
| Plastic: | |
| polyphenylene oxide | 51 |
| ABS | 30 |
| 66 nylon | 52 |
| polycarbonate | 57 |
| polystyrene | 36 |
| acrylic | 48 |
| rigid vinyl chloride | 34 |
| polyester | 49 |
| polyethylene terephthalate | 21 |
| phenol | 54 |
| polybutylene terephthalate | 14 |

In the present embodiment, the information on the tire transmitted from the tire sensor unit 10 is received at the single receiving device 20. However, each tire may be provided with a receiving device on the periphery thereof. In this instance, the radio transmission section 14 of the tire sensor unit 10 may modulate electromagnetic induction radio waves by varying the load impedance of the receiving side coil 51 corresponding to the information to be transmitted. Also, the radio transmission section 14 of the tire sensor unit 10 may generate microwaves which is modulated corresponding to the information to be transmitted by varying the load impedance of the receiving side antenna 54 corresponding to the information to be transmitted.

### INDUSTRIAL APPLICABILITY

As described above, in the tire monitoring system according to the present invention, electric power is fed from the car body to the tire sensor unit mounted on each tire in a non-contact manner. Consequently, the tire sensor unit can dispense with a battery, and it becomes unnecessary to replace a battery. Also, since it is unnecessary to attach a battery to the tire, the process for adjusting the weight balance of the tire can be conducted as easily as in the conventional art.

1. A tire monitoring system comprising:
a tire sensor unit which is mounted on each tire of a car to radio-transmit information on tire pressure and tire temperature;
a receiving device which is provided in the car body to receive the information on the tire pressure and the tire temperature transmitted from the tire sensor unit, and
a display device to display the tire condition based on the information received at the receiving device, and
further comprising:
a non-contact type power supply portion which is provided in the car body to radio-transmit energy; and
a non-contact type power receiving portion which is provided in the tire sensor unit to generate direct-current power by the energy transmitted from the non-contact type power supply portion,
wherein electric power necessary for activating the tire sensor unit is supplied from the non-contact type power receiving portion, and
wherein the display device is provided with a tire abnormality judging section, a warning lamp, and a warning buzzer, and the tire abnormality judging section judges the tire to be abnormal when the tire pressure and the tire internal temperature vary from a predetermined value and outputs to the warning lamp and the warning buzzer.

2. The tire sensor unit according to claim 1, wherein the radio-transmission of energy from the non-contact type power supply portion to the non-contact type power receiving portion is conducted by electromagnetic induction.

3. The tire sensor unit according to claim 1, wherein the radio-transmission of energy from the non-contact type power supply portion to the non-contact type power receiving portion is conducted by microwaves.
